(19) United States
(12) Patent Application Publication
(10) Pub. No.: US 2009/0211652 A1
(43) Pub. Date: Aug. 27, 2009

(54) Pump, in Particular Motor/Pump Unit for a Power Steering System of a Motor Vehicle

(76) Inventor: Joerg Skopnik, Dorsten (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/990,892

(22) PCT Filed: Jul. 10, 2006
(86) PCT No.: PCT/EP2006/006737

§ 371 Date: Feb. 27, 2009

(30) Foreign Application Priority Data
Aug. 23, 2005 (DE) 20 2005 013 303.5

(51) Int. Cl. F04B 49/22

(52) U.S. Cl. 137/511

(57) ABSTRACT

A pump, in particular a motor/pump unit for a power steering system of a motor vehicle, including a pressure-limiting valve which has a fluid inlet and a fluid outlet, the pump having a suction port which is associated with a fluid reservoir and a pressure port which is associated with a consumer and to which the fluid inlet of the pressure-limiting valve is coupled, characterized in that the fluid outlet of the pressure-limiting valve is connected with the suction port of the pump.

### CROSS-REFERENCE TO RELATED APPLICATIONS

This application is a National Stage of International Application No. PCT/EP2006/006737 filed Jul. 10, 2006, which claimed priority to German Patent Application No. 20 2005 013 303.5 filed Aug. 23, 2005, the disclosures of both are incorporated herein by reference in their entirety.

### BACKGROUND

Various embodiments of a pump, in particular a motor/pump unit for a power steering system of a motor vehicle are described herein. The motor/pump comprises a pressure-limiting valve which has a fluid inlet and a fluid outlet, the pump having a suction port which is associated with a fluid reservoir and a pressure port which is associated with a consumer and to which the fluid inlet of the pressure-limiting valve is coupled.

A generic motor/pump unit which, apart from applications in power steering systems, can also be used in other areas, e.g. in a roll-stabilizing system, is known from German Utility Model 203 02 534. In this known unit, as is generally usual, a pressure-limiting valve is provided in order to avoid undesirably high pressures in a hydraulic circuit. It is prior art that hydraulic fluid which has flowed through the pressure-limiting valve is returned into a pressureless reservoir or a pressureless tank, in order to be received into the hydraulic circuit again from there via a suction port of the pump.

Whilst flowing through the pressure-limiting valve, portions of gas become released from the hydraulic fluid and form a fluid/gas mixture which is diverted into the reservoir. Part of this process takes place with a considerable development of noise. Further problem areas are the sensitivity of the pump during the cold start phase and also the inconstant volumetric efficiency and the overall efficiency with an increasing torque.

### BRIEF SUMMARY

The present application describes various embodiments of a pump which operates with low noise with a constantly high efficiency.

In one embodiment of the pump, the fluid outlet of the pressure-limiting valve is connected with the suction port of the pump. This measure causes the portions of gas which are released during through-flow of the pressure-limiting valve to dissolve again owing to the compression which is directly initiated, and to hold the circulated fluid/gas mixture in equilibrium. Thereby, for one thing, the usual noise level is drastically reduced and, for another thing, a constant efficiency, some percentage points higher as a whole, is produced.

In another possible embodiment, the pump has a cover into which both the suction port of the pump and also a port for the fluid outlet of the pressure-limiting valve are integrated. This ensures a local proximity of the relevant ports and connecting is possible particularly easily.

In this embodiment, the cover can be constructed as a resonator cover. Especially in motor/pump units a resonator chamber is frequently provided to reduce pulsations which occur in particular when an external gear pump is used. If, for example, the cover is constructed in a bell shape, then it can substantially form the resonator chamber and can be referred to as a resonator cover. Therefore, a resonator which in conventional motor/pump units it constructed in the pump or is arranged as a separate component, e.g. on an end face of the pump, can be dispensed with.

The cover can be constructed as a diecast part or a deep-drawn part. These production methods are known and efficient for such components and can also be used without problems for the production of covers for the pump according to the invention, in particular the motor/pump unit according to the invention.

In another embodiment, the ports which are integrated in the cover are connected via a piece of tubing. Pieces of tubing constitute a very simple and favorably priced possibility for a connection.

In this embodiment, the piece of tubing is preferably connected by tubing connectors which are integrated in the cover. The connection can thereby be produced very simply.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows the hydraulic plan of a fluid circuit according to the prior art;

FIG. 2 shows the hydraulic plan of a fluid circuit with the use of a pump according to the invention, in particular a motor/pump unit according to the invention;

FIG. 3 shows a perspective top view onto a cover of the motor/pump unit according to the invention; and

FIG. 4 shows a perspective bottom view of the cover of FIG. 3.

### DETAILED DESCRIPTION OF THE INVENTION

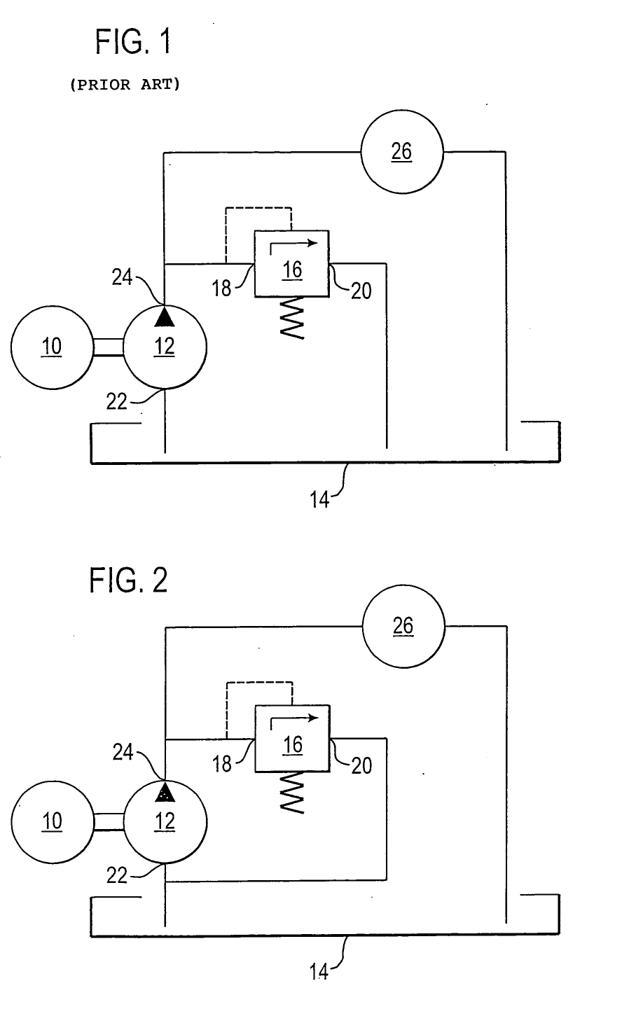

In FIG. 1 the hydraulic plan of a fluid circuit is illustrated, in particular for a power steering system of a motor vehicle. The hydraulic plan shows diagrammatically here a motor 10, a pump 12, a fluid reservoir 14, and a pressure-limiting valve 16 which has a fluid inlet 18 and a fluid outlet 20. The pump 12 has a suction port 22 which is associated with the fluid reservoir 14, and a pressure port 24 which is associated with a consumer 26 and to which the fluid inlet 18 of the pressure-limiting valve 16 is coupled. In this case, the consumer 26 may for example be a rotary slide valve which is coupled to a piston/cylinder unit. Under suitable pressure conditions, a hydraulic circuit is therefore produced in which the hydraulic fluid is sucked by the pump 12 from a fluid reservoir 14 and is passed on to a consumer 26. The consumer 26 has a return flow duct which conducts the hydraulic fluid into the fluid reservoir 14 again.

When the pressure in the above-mentioned hydraulic circuit becomes too great, the pressure-limiting valve 16 opens. In the prior art according to FIG. 1, the following fluid circuit is therefore produced: The pump 12 sucks hydraulic fluid out of the fluid reservoir 14 and conducts it via its pressure port 24 to the fluid inlet 18 of the pressure-limiting valve 16. The hydraulic fluid flows through the pressure-limiting valve 16, leaves it via a fluid outlet 20 and is supplied again to the fluid reservoir 14.

On flowing through the pressure-limiting valve 16, portions of gas are released from the hydraulic fluid, so that a fluid/gas mixture is present at the fluid outlet 20. When the fluid/gas mixture is conducted from the fluid outlet 20 of the pressure-limiting valve 16 into the pressureless fluid reservoir 14, the fluid/gas mixture becomes separated with great turbulence and intense noise.

With the use of a pump 12 according to the invention or a motor/pump unit according to the invention (FIG. 2) with the pressure-limiting valve 16 closed, the hydraulic circuit is identical to the hydraulic circuit of FIG. 1 which has been described. The difference becomes clear when the pressure-limiting valve 16 opens under increased pressure. In contrast to the prior art, in this case the hydraulic fluid is supplied directly to the suction port 22 of the pump 12 after leaving the pressure-limiting valve 16 via the fluid outlet 20.

When the fluid/gas mixture is passed on directly to the suction port 22 of the pump 12 and is thus subjected to a direct compression again, then the portion of gas which is released in the pressure-limiting valve 16 becomes dissolved again and holds the circulated fluid/gas mixture in equilibrium.

Apart from the drastically reduced noise level, further advantages are produced in that hydraulic fluid which is already under pressure is present at the suction port 22 of the pump 12 when the pressure-limiting valve 16 is in operation. The pump 12 therefore has to overcome a smaller pressure difference, which results in a reduced current consumption and stresses the bearing of the pump rotor less. In addition, the cold-running characteristics of a motor/pump unit are improved, because the hydraulic fluid which is returned via the pressure-limiting valve 16 is heated up compared with hydraulic fluid of the fluid reservoir and therefore likewise brings the components concerned more quickly to the operating temperature.

An advantageous embodiment of the invention is explained in further detail below by means of a motor/pump unit, in particular by means of a cover 28 of this motor/pump unit. It will be appreciated, however, that the embodiments described herein generally to hydraulic pumps and that the cover 28 can therefore also be a pump cover.

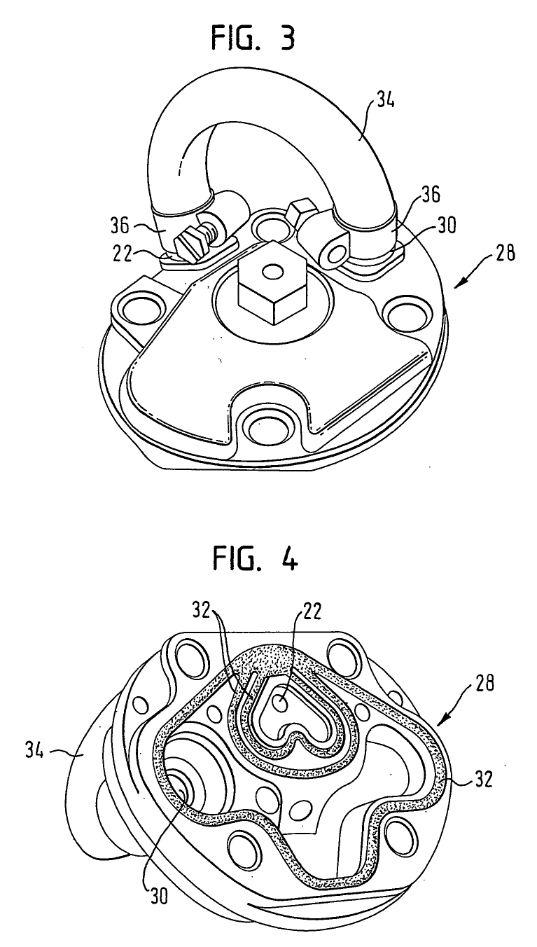

FIGS. 3 and 4 show by way of example a preferred embodiment of the cover 28 of the motor/pump unit. Both the suction port 22 of the pump 12 and also a port 30 for the fluid outlet of the pressure-limiting valve are integrated in the cover 28. In this case, the cover 28 is constructed as a resonator cover and is formed as a diecast part. A production as a deep-drawn part or by another suitable method is likewise possible.

In the bottom view of FIG. 4, in addition to the port 30 for the fluid outlet, the suction port 22 of the pump can also be seen. The cover 28 sits on a housing in which the fluid reservoir, the pump 12 and the pressure-limiting valve 16 are housed. The sealing between the cover 28 and the pump or between the cover 28 and the housing is achieved by elastic seals 32.

The ports 22, 30 which are integrated in the cover are connected via a tubing piece 34. This can be seen in the top view of FIG. 3. The tubing piece 34 is connected here by tubing connectors (not shown) which are integrated in the cover 28. The tubing piece 34 is placed onto the tubing connectors and secured by hose clips 36 against slipping out, the fastening of the tubing piece also being able to take place in a different way.

In further embodiments, it is possible for the fluid outlet 20 of the pressure-limiting valve 16 and the suction port 22 of the pump 12 not to be connected by a tube running outside the motor/pump unit, but rather for example for them to be connected by a duct running inside or by a connecting bore in the housing or in the cover 28.

In accordance with the provisions of the patent statutes, the principle and mode of operation of the motor/pump unit have been explained and illustrated in its various embodiments. However, it must be understood that the motor/pump units described herein may be practiced otherwise than as specifically explained and illustrated without departing from its spirit or scope.

1. A pump, in particular a motor/pump unit for a power steering system of a motor vehicle, comprising a pressure-limiting valve which has a fluid inlet and a fluid outlet, the pump having a suction port which is associated with a fluid reservoir and a pressure port which is associated with a consumer and to which the fluid inlet of the pressure-limiting valve is coupled, wherein the fluid outlet of the pressure-limiting valve is connected with the suction port of the pump.

2. The pump according to claim 1, wherein the pump has a cover into which both the suction port of the pump and also a port for the fluid outlet of the pressure-limiting valve are integrated.

3. The pump according to claim 2, wherein the cover is constructed as a resonator cover.

4. The pump according to claim 2, wherein the cover is constructed as a diecast part or deep-drawn part.

5. The pump according to claim 2, wherein the ports which are integrated in the cover are connected via a tubing piece.

6. The pump according to claim 5, wherein the tubing piece is connected by tubing connectors which are integrated in the cover.
